(19) United States
(12) Patent Application Publication
(10) Pub. No.: US 2024/0227293 A1
(43) Pub. Date: Jul. 11, 2024

(54) LIQUEFIER ASSEMBLY

(71) Applicant: E3D-Online Limited, Chalgrove Oxfordshire (GB)

(72) Inventors: Sanjay Mortimer, Chalgrove (GB); Rory Yonge, Chalgrove (GB); Dylan Roberts, Chalgrove (GB); Travis Williams, Chalgrove (GB)

(73) Assignee: E3D-Online Limited, Chalgrove Oxfordshire (GB)

(21) Appl. No.: 18/559,326

(22) PCT Filed: May 9, 2022
(86) PCT No.: PCT/GB2022/051173

§ 371 Date: Nov. 6, 2023

(30) Foreign Application Priority Data
May 7, 2021 (GB) 2106553.7

(51) Int. Cl. B29C 64/295; B29C 64/209; B33Y 30/00

(52) U.S. Cl. CPC B29C 64/295; B29C 64/209; B33Y 30/00

(57) ABSTRACT

The invention relates to a liquefier assembly (1) for an additive manufacturing system. The assembly (1) includes a heat sink (2), a nozzle (3) releasably connected to the heat sink (2) and a heater (4) connected to the heat sink (2) by a coil spring (5). The nozzle (3) has a 5 nozzle tip (31) at one end and the heater (3) is between the nozzle tip (31) and the heat sink (2) when the nozzle (3) is connected to the heat sink (2) and is biased away from the heat sink (2), toward the nozzle tip (31) and into thermal contact with a surface of the nozzle (3).

This invention relates generally to additive manufacturing systems for producing three-dimensional (3D) parts and particularly to liquefier assemblies for such systems. More specifically, although not exclusively, this invention relates to such a liquefier assembly having a replaceable nozzle.

Additive manufacturing, also called 3D printing, is a process in which a part is made by adding material, rather than subtracting material as in traditional machining. A part is manufactured from a digital model using an additive manufacturing system, commonly referred to as a 3D printer. A typical approach is to slice the digital model into a series of layers, which are used to create two-dimensional path data, and to transmit the data to a 3D printer which manufactures the part in an additive build style. There several different methods of depositing the layers, such as stereolithography, ink jetting, selective laser sintering, powder/binder jetting, electron-beam melting and material extrusion.

In a typical extrusion-based additive manufacturing system, such as a fused deposition modelling system, a part may be formed by extruding a viscous, molten thermoplastic material from a distribution head along predetermined paths at a controlled rate. The head includes a liquefier, which receives thermoplastic material, normally in the form of a filament. A drive mechanism engages the filament and feeds it into the liquefier. The filament is fed through the liquefier, where it melts to produce the flow of molten material, and into a nozzle for depositing the molten material onto a substrate. The molten material is deposited along the predetermined paths onto the substrate, where it fuses to previously deposited material and solidifies as it cools, gradually building the part in layers.

It is known to provide liquefier assemblies for extrusion-based additive manufacturing systems, in which the nozzle is replaceable. However, replacement of such nozzles generally requires the nozzle and surrounding components to be at a relatively high temperature, often in the region of 250-300° C. This can create a significant risk to the person changing the nozzle.

It would therefore be advantageous to provide a liquefier assembly that at least mitigates these and other issues associated with known designs.

Accordingly, a first aspect of the invention provides a liquefier assembly for an additive manufacturing system, the assembly comprising a body, e.g. for mounting the liquefier assembly to an additive manufacturing system, a nozzle releasably connected to the body and a heater biased into thermal contact with the nozzle.

Thus, the invention provides a liquefier assembly that enables the nozzle to be replaced when the assembly is cold. Any movement that results from thermal expansion, which necessitates installation of the nozzle when traditional liquefier assemblies are hot, can therefore be taken up by the biasing force applied to the heater.

The body may comprise a heat exchange body, such as a heat sink. The nozzle may be releasably connected to the body. The nozzle may comprise a nozzle tip, which may be at or adjacent one end. The heater may be between the nozzle tip and the body. The heater may be biased away from the body and/or toward the nozzle tip.

Another aspect of the invention provides a liquefier assembly for an additive manufacturing system, the assembly comprising: a heat exchange body; a nozzle releasably connected to the heat exchange body and having a nozzle tip at one end; and a heater between the nozzle tip and the heat exchange body, which is biased away from the heat exchange body, toward the nozzle tip and into thermal contact with a surface of the nozzle.

The nozzle may be releasably connected to the body at or adjacent an end, e.g. a first end. The nozzle tip may be at or adjacent a second end. The heater may be movable, e.g. relative to the body and/or relative to the nozzle. The heater may be movably mounted to, or relative to, the body.

The heater may surround the nozzle. At least part of the nozzle may be received within the heater. The heater may comprise a sleeve, for example which surrounds the nozzle and/or within which at least part of the nozzle may be received or inserted. The heater may comprise a heating element, which may be in, on, around or otherwise associated with and/or in thermal contact with the sleeve.

The heater may be movable, e.g. relative to the body and/or relative to the nozzle. The heater may be movable to facilitate insertion of the nozzle into the heater and/or to facilitate connection of the nozzle with the body. The heater may be movable such that the nozzle may be inserted, in use, into the heater when the nozzle is misaligned with the body. The heater may be movable such that the nozzle may be brought into alignment with the body for connection therewith, e.g. from the misaligned position, condition or orientation. The heater may be movable such that the nozzle may be inserted, in use, into the heater when the nozzle is misaligned with the body and subsequently brought into alignment with the body for connection therewith.

Another aspect of the invention provides a liquefier assembly for an additive manufacturing system, the assembly comprising: a body and a heater movably mounted relative to the body, thereby to enable a nozzle to be inserted, in use, into the heater when the nozzle is misaligned with the body and subsequently brought into alignment with the body for connection therewith.

The heater may be movable in, along or about multiple dimensions or axes. The dimensions or axes may comprise one or more dimensions or axes perpendicular to the nozzle. The dimensions or axes may comprise a dimension or axis along the axis of the nozzle or body or the connection therebetween. The heater may be movable by pivoting about one or more of the axes. The heater may be movable about one or more rotational or pivotal axes. The heater may be movable freely, i.e. in all directions, dimensions and/or axes.

The heater may be movable along a first dimension or direction, which may be toward and/or away from the body. The heater may be movable along a second dimension or direction, which may be perpendicular to the first dimension or direction. The heater may be pivotable about one or more axes, at least one of which may be perpendicular to the first dimension or direction.

The heater may be mounted to the body, e.g. directly or indirectly via another feature such as a housing. The heater may be mounted to the body via a resilient means.

Another aspect of the invention provides a liquefier assembly for an additive manufacturing system, the assembly comprising: a body and a heater connected to, or mounted relative to, the body by or via a resilient means.

The resilient means may comprise a resilient element, mechanism, assembly or member. The resilient means may be mounted, connected or secured to the body, e.g. either directly or indirectly via another feature such as a housing. The resilient means may be mounted, connected or secured to a connector of the body.

Another aspect of the invention provides a body, e.g. for a liquefier assembly as described above. The body may comprise a heat exchange body. The body may comprise a connector, e.g. for connection with the resilient means of the liquefier assembly.

The resilient means may be mounted, connected or secured to the heater, e.g. either directly or via another feature. The resilient means may be mounted, connected or secured to a connector of the heater.

Another aspect of the invention provides a heater, e.g. for a liquefier assembly as describe above. The heater may comprise a hole, e.g. for slidingly receiving the nozzle of the liquefier assembly. The heater may comprise a connector, e.g. for connection with the resilient means of the liquefier assembly.

The or each connector may comprise a projection, e.g. a spigot, or a recess or hole. The or each connector, projection, spigot or hole may comprise a lip or rim, e.g. for engaging and/or retaining the resilient means. The lip or rim may project radially outwardly or inwardly from the projection, spigot, recess or hole. The projection or spigot may be annular. The projection or spigot of the body may at least partially surround the nozzle. The projection or spigot of the heater may at least partially surround the nozzle and/or the hole for slidingly receiving the nozzle of the liquefier assembly.

The resilient means may be configured to be compressed, in use, as the nozzle is connected to the heat exchange body. The resilient means may be configured to bias the heater into thermal contact with the nozzle surface. The resilient means may be configured to allow the aforementioned movement of the heater, e.g. relative to the body and/or the nozzle. The resilient means may be configured to bias, in use, the heater to return to a predetermined position, condition and/or orientation.

The resilient means may have a first end, which may be connected to the body. The resilient means may have a second end, which may be connected to the heater. The resilient means may be connected to the body and to the heater such that the heater is able to move relative to the body.

The resilient member may be tubular or comprise a tubular member, which may be formed of a resilient material. The tubular member, e.g. a first end thereof, may receive or engagingly receive a projection or spigot of the body or a lip or rim thereof, e.g. with an interference fit. The tubular member, e.g. a second end thereof, may receive or engagingly receive a projection or spigot of the heater or a lip or rim thereof, e.g. with an interference fit.

The resilient member or tubular member may, but need not, comprise a spring. The spring may comprise a coil spring, stamped spring, wireform spring or leaf spring, which may but need not be tubular. The spring may comprise a compression and/or torsion spring. The tubular member may be solid or substantially solid. The tubular member may comprise one or more holes or openings.

The resilient member may allow the heater to move, in use, relative to the body in at least two dimensions, for example in three dimensions or movable freely (i.e. in all directions), thereby enabling the nozzle to be inserted into the heater when the nozzle is misaligned with the body.

The nozzle may comprises a connection feature, which may be at or adjacent one end, e.g. the first end. The connection feature may be for cooperating with a connection feature of the body. The connection features may comprise one or more threads. Additionally or alternatively, the connection features may comprise a quick release mechanism, a quick connect mechanism or a quick disconnect mechanism. Additionally or alternatively, the connection features may comprise a ball and detent mechanism, for example a sprung ball and detent mechanism. The nozzle may comprise one of the ball and detent, while the body may comprise the other of the ball and detent. Additionally or alternatively, the connection features may comprise a bayonet mechanism. Additionally or alternatively, the connection features may comprise a clamping mechanism.

The nozzle may comprise a liquefier tube, which may be between the nozzle tip and the connection feature. The liquefier tube may span a gap between the heater and the body. The heater may be biased into thermal contact with the nozzle tip, e.g. a surface of the nozzle tip. The liquefier tube may be formed of a different material to the connection feature and/or to the nozzle tip. The liquefier tube may be less thermally conductive than the connection feature and/or than the nozzle tip. The liquefier tube may comprise a different part or component to, or may be formed integrally with, the connection feature and/or the nozzle tip.

The outer profile of the nozzle may be configured such that the heater is able to slide, e.g. therealong and/or into abutting thermal contact with the nozzle tip or surface thereof. The thermally contacting surfaces, e.g. of the heater and/or nozzle tip, may comprise one or more annular surfaces. At least part or some of the annular surfaces may extend in a radial direction and/or may be radial and/or planar. At least part or some of the annular surfaces may be tapered. The tapered annular surfaces may comprise a straight taper or a curved taper. The tapered annular surfaces may be conical or frustoconical.

The nozzle tip may comprise a head, which may be enlarged. At least part or some of the annular surfaces may describe part of the head. At least part or some of the annular surfaces may describe a transition between an upstream portion of the nozzle or nozzle tip and the head. The nozzle tip may comprise an upstream portion, which may be upstream the head. The upstream portion may comprise at least part or some of the annular surfaces, which may be tapered, conical or frustoconical. Alternatively, the upstream portion may comprise a cylindrical surface, e.g. which enables the heater or sleeve to slide therealong and/or into contact with the head or the annular surface(s) of the head.

The assembly or nozzle may comprise an interface material, which may be between at least part of the thermally contacting surfaces, e.g. of the heater and nozzle tip. The interference material may comprise or be in the form of a coating on at least one of the thermally contacting surfaces. Additionally or alternatively, the interference material may comprise or be in the form of a separate member. The assembly or nozzle may comprise an interface member, for example a disc or washer. The interface member may be planar, angled, tapered, conical or frustoconical, e.g. to correspond to the thermally contacting surface(s). The interface member may comprise the interface material. The interface member or material may comprise a nanostructure, for example a two-dimensional nanostructure. The interface member or material may comprise graphene. The interface member or material may comprise one or more or multiple nanostructure layers or multiple layers of graphene.

The nozzle may comprise a stop. The stop may engage the body, for example when the nozzle is engaged or engaged fully therewith. The stop may comprise a flange. The stop may be configured to abut or bottom out on a surface of the body, for example when the nozzle is engaged or engaged fully therewith. The stop may be between the connection feature and the nozzle tip, for example between the connection feature and the liquefier tube.

At least part of the nozzle tip may comprise a first material. At least part of the liquefier tube may comprise a second material. At least part of the connection feature may comprise a third material. At least two of the materials may be different. The second material may be less thermally conductive than the first material and/or than the third material. The first material may be more wear resistant than the first material and/or than the second material.

In some examples, the nozzle may be formed of more than one material. The nozzle tip or first material may comprise a thermally conductive material. The nozzle tip or first material may comprise a copper alloy, such as brass. The nozzle tip or first material may comprise a wear resistant material. The nozzle tip or first material may comprise a ferrous material or alloy, such as steel, stainless steel or hardened steel, or tungsten or a tungsten alloy. The liquefier tube or second material may comprise a ferrous material or alloy, such as steel or stainless steel. The connection feature or third material may comprise a thermally conductive material. The connection feature or third material may comprise copper or a copper alloy, such as brass.

The nozzle may comprise two or more parts, which may be connected or secured together, for example by an interference fit or by brazing or welding. The nozzle may comprise two or more portions, which may be formed integrally with one another but from different materials. The two or more portions may be formed by an additive manufacturing process. The nozzle may comprise a first part, which may comprise a connection part or connection sleeve part. The connection part or connection sleeve part may comprise a heat spreader. The connection part may comprise the connection feature. The nozzle may comprise a second part, which may comprise a liquefier tube part. The nozzle may comprise a third part, which may comprise a nozzle tip part. The liquefier tube part may be secured, e.g. by an interference fit or by brazing or welding, to the first and/or third parts.

Another aspect of the invention provides a nozzle, e.g. for a liquefier assembly as described above. The nozzle may, but need not, comprise any of the aforementioned nozzle features.

The nozzle or assembly may comprise a tip cover or tip sock, hereinafter tip cover. The tip cover may be mounted on, to or over the nozzle tip, e.g. by an interference fit. The tip cover may be for insulating the nozzle tip. The tip cover may comprise an insulating material. The tip cover may comprise a resilient material. The tip cover may comprise a viscoelastic or elastomeric material. The elastomeric material may comprise a natural or synthetic elastomer. The elastomeric material may comprise silicone.

The tip cover may comprise a engaging feature, which may engage or may be for engaging the engaging feature of the nozzle tip, e.g. to retain the tip cover thereon. The engaging feature of the tip cover may comprise a recess or projection, e.g. a lip. The engaging feature of the tip cover may extend inwardly and/or about at least part of its periphery, e.g. its inner periphery. The engaging feature of the tip cover may be at or adjacent an open end of the tip cover or intermediate its ends. The engaging feature of the tip cover may be continuous or discontinuous. The engaging feature of the nozzle tip may comprise a projection, recess or shoulder. The engaging feature of the nozzle tip may be continuous or discontinuous.

The tip cover, e.g. the open end thereof, may abut and/or engage, or may be configured to abut and/or engage, the heater or a heater cover mounted over the heater, for example when the nozzle is connected to the body. The assembly may comprise a heater cover, which may be mounted over the heater, e.g. to insulate the heater. The heater cover may comprise a resilient material. The heater cover may comprise a viscoelastic or elastomeric material. The elastomeric material may comprise a natural or synthetic elastomer. The elastomeric material may comprise silicone.

The tip cover may comprise an indicator, which may be a visual indicator. The indicator may identify one or more characteristics of the nozzle tip to which it is mounted. The indicator may identify, for example, the wear resistance and/or thermal conductivity of the nozzle tip to which it is mounted. The indicator may comprise a colour. The colour may comprise a primary colour. The colour may comprise a bright colour.

The nozzle, nozzle tip or tip cover comprises a thermochromic substance or pigment, hereinafter pigment. The heater cover may comprise a thermochromic pigment. The thermochromic pigment may be reversible or irreversible. The thermochromic pigment may be configured to indicate the temperature of the nozzle tip. The thermochromic pigment may be configured to change colour gradually, for example according to a predetermined scale and/or for allowing a user to estimate the temperature of the nozzle tip. Additionally or alternatively the or a further thermochromic pigment may be configured to indicate that the nozzle tip has been heated to a temperature above a predetermined threshold value.

Another aspect of the invention provides a liquefier nozzle tip cover, e.g. for insulating the nozzle tip of a liquefier assembly as described above. The tip cover may comprise any of the aforementioned tip cover features.

The body may comprise one or more, e.g. a plurality of, heat exchange surfaces, features, members or fins. The body may comprise a core, for example with a plurality of fins extending radially from the core. The body or core may be substantially cylindrical. The body or core may comprise a passageway, e.g. an axial passageway. The passageway may extend along and/or through the body or core. The passageway may comprise the connection feature, for example internal threads or a quick release mechanism, a quick connection mechanism or a quick disconnect feature.

The body may comprise an upstream end, which may comprise a connection feature, e.g. for connection with a feed mechanism. The connection feature may comprise a head and/or a necked portion. Alternatively, the connection feature may comprise one or more threads. The upstream end may be threaded or comprise a thread. The assembly or body may comprise a nut, which may threadedly engage the upstream end of the body. The feed mechanism may comprise a filament feed mechanism. In some examples, the body is received within a housing. The assembly may comprise a housing, e.g. within which the body is received. In such examples, the assembly may comprise the or a feed mechanism, e.g. the or a filament feed mechanism. In such examples, the heater may be mounted, e.g. via the resilient means, to or directly to the housing. The assembly may comprise a guide, which may be received within the passageway at the upstream end of the body.

The body may comprise a downstream end. The connection feature may extend from the downstream end and/or along part of the passageway. The downstream end may comprise a stop surface. The stop of the nozzle may be configured to abut or bottom out on the stop surface of the body, for example when the nozzle is engaged or engaged fully therewith. The downstream end may comprise an annular wall, which may surround the stop surface. The annular wall may describe or define a recess. The stop surface may comprise a base or base surface of the recess.

The assembly may comprise a flow inducing means, e.g. for inducing a flow of fluid around and/or about and/or across and/or through the body. The assembly or flow inducing means may comprise a fan, e.g. for inducing a flow of air around and/or about and/or across and/or through the body. In other examples, the flow inducing means may comprise a pump for inducing a flow of liquid around and/or about and/or across and/or through the body.

The heater may comprise a mandrel. The mandrel may comprise one or more, e.g. a plurality of, windings thereon or therearound. The windings may be received within a winding groove, e.g. a circumferential winding groove, of or in the mandrel. The mandrel may comprise a wire groove, which may be circumferential.

The heater may comprise a thermocouple. The thermocouple may be captivated between the mandrel and the windings. The thermocouple may be received within a thermocouple receptacle of or in the mandrel. The thermocouple receptacle may be recessed with respect to an outer surface of the mandrel. The thermocouple receptacle may be recessed with respect to the winding groove of the mandrel.

The mandrel may comprise a catch, The catch may comprise a protrusion, pin, hook or other protruding element or recess. The windings may comprise or be provided by a wire, e.g. a winding wire. The heater may comprise the wire or winding wire. The wire or winding wire may comprise an intermediate portion. The intermediate portion may be hooked over or around the catch. The intermediate portion may be wound around the mandrel, e.g. to provide the windings. The wire or winding wire may comprise a sheath, which may surround the wire. The intermediate portion may be free of the sheath. A sheathed portion of the wire or winding wire may extend along and/or be received within the wire groove, e.g. a first side thereof.

The thermocouple may be connected, e.g. electrically connected, to a wire, e.g. a thermocouple wire. The heater may comprise the wire or thermocouple wire. The wire or thermocouple wire may comprise a sheath, which may surround the wire. A sheathed portion of the wire or thermocouple wire may extend along and/or be received within the wire groove, e.g. a second side thereof opposite the first side.

The mandrel may comprise a thermocouple groove or a thermocouple wire groove, which may be axial or extend axially along the mandrel. The thermocouple groove or thermocouple wire groove may be recessed with respect to the outer surface, or the winding groove, of the mandrel. The wire or thermocouple wire, e.g. a sheathed portion thereof, may extend along and/or be received within the thermocouple groove or a thermocouple wire groove.

The heater may comprise a protective sleeve. The protective sleeve may at least partially surround the windings. The protective sleeve may include a split, which may be axial. The protective sleeve may comprise a pair of arms. One arm may be on each or either side of the split, e.g. for expanding the sleeve for fitting the protective sleeve over the mandrel.

The protective sleeve may comprise a wire passage, e.g. through which the wires extend. The wire passage may be described between the arms. The arms may extend along part of the wires extending through the wire passage. Thus, the arms may provide support to the wires. The arms may also provide a bracing surface, which may inhibit bending of the wires.

The protective sleeve may comprises a recess or hole, e.g. for receiving part of the catch of the mandrel. The catch may extend into and/or through the recess or hole. The catch may provide a stop that engages the hole, e.g. for inhibiting rotation of the protective sleeve with respect to the mandrel. Thus, interaction between the catch and the recess or hole may protect the windings and/or inhibit them from unwinding.

Another aspect of the invention provides a kit of parts, e.g. for a liquefier assembly as described above. The kit may comprise two or more nozzles as described above. Each nozzle may comprise a different configuration. Each nozzle may comprise a tip cover thereon or thereover having a different indicator.

For the avoidance of doubt, any of the features described herein apply equally to any aspect of the invention.

Another aspect of the invention provides a computer program element comprising and/or describing and/or defining a three-dimensional design, e.g. of the assembly, nozzle or tip cover described above or an embodiment thereof. The three-dimensional design may be for use with a simulation means or an additive or subtractive manufacturing means, system or device.

The computer program element may be for causing, or operable or configured to cause, an additive or subtractive manufacturing means, system or device to manufacture the nozzle or tip cover described above or an embodiment thereof. The computer program element may comprise computer readable program code means for causing an additive or subtractive manufacturing means, system or device to execute a procedure to manufacture the assembly, nozzle or tip cover described above or an embodiment thereof.

A yet further aspect of the invention provides the computer program element embodied on a computer readable medium.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

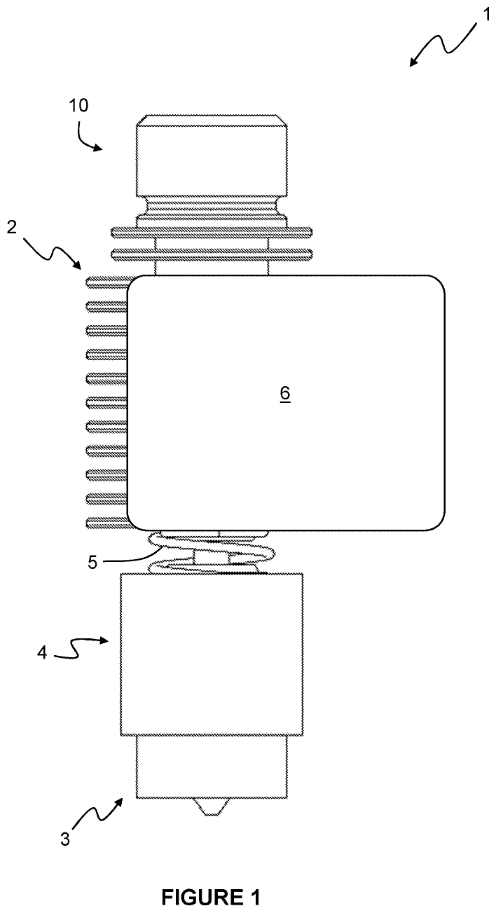

FIG. 1 is side view of a liquefier assembly according to a first example;

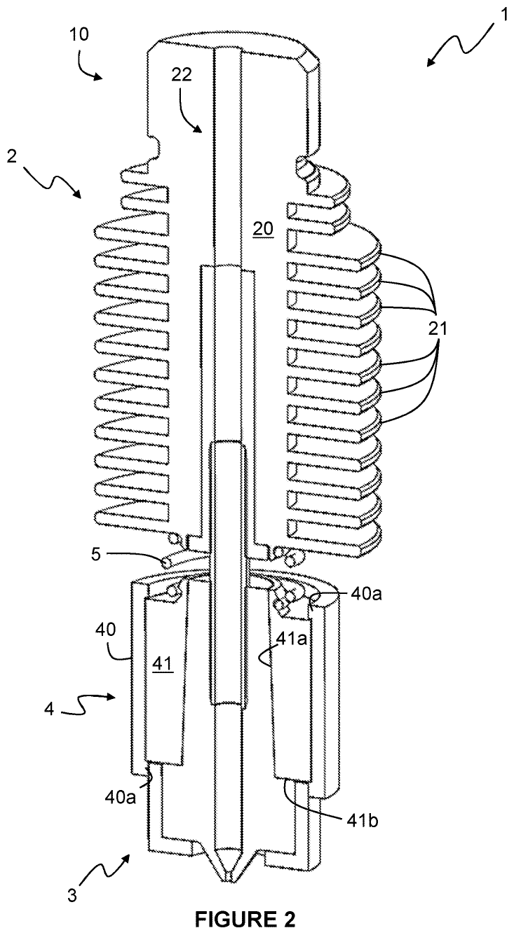

FIG. 2 is a cross-sectional perspective view of the liquefier assembly of FIG. 1 through a plane along the axis of the assembly, with the fan omitted;

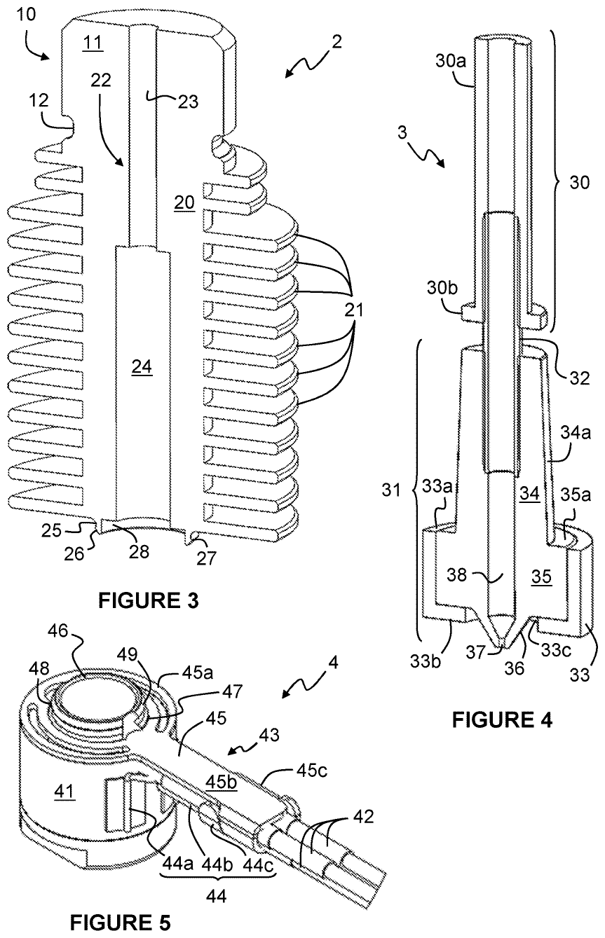

FIG. 3 is a cross-sectional perspective view of the heat sink of the liquefier assembly of FIGS. 1 and 2;

FIG. 4 is a cross-sectional perspective view of the nozzle of the liquefier assembly of FIGS. 1 and 2;

FIG. 5 is a perspective view of the heater of the liquefier assembly of FIGS. 1 and 2;

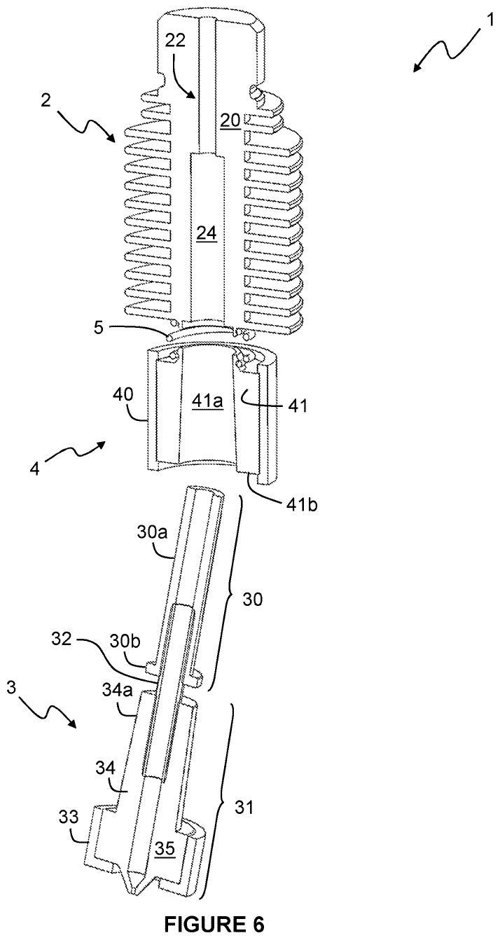

FIG. 6 is a cross-sectional perspective view of the liquefier assembly of FIGS. 1 and 2 illustrating a misalignment between the nozzle and the heat sink prior to insertion of the nozzle;

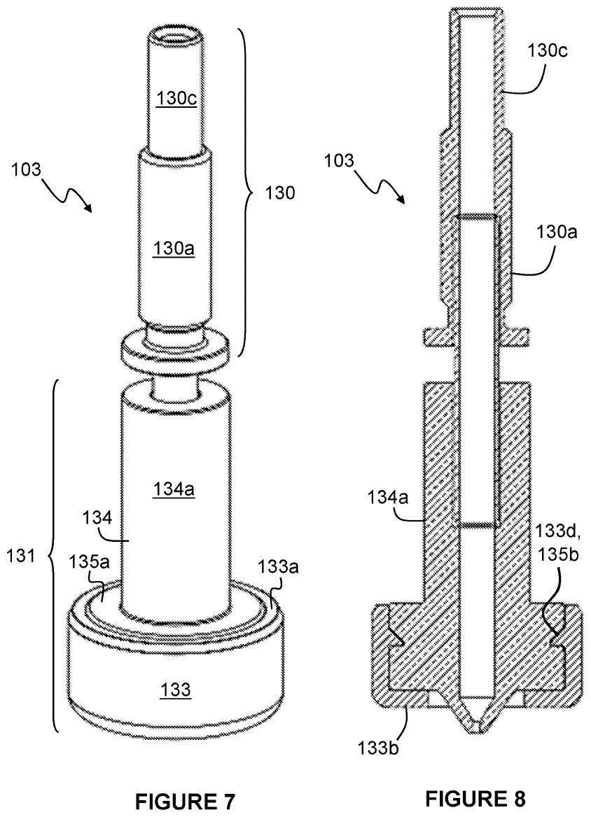

FIG. 7 is a perspective view of an alternative nozzle;

FIG. 8 is a cross-sectional view of the nozzle of FIG. 7 through a plane along the axis of the assembly;

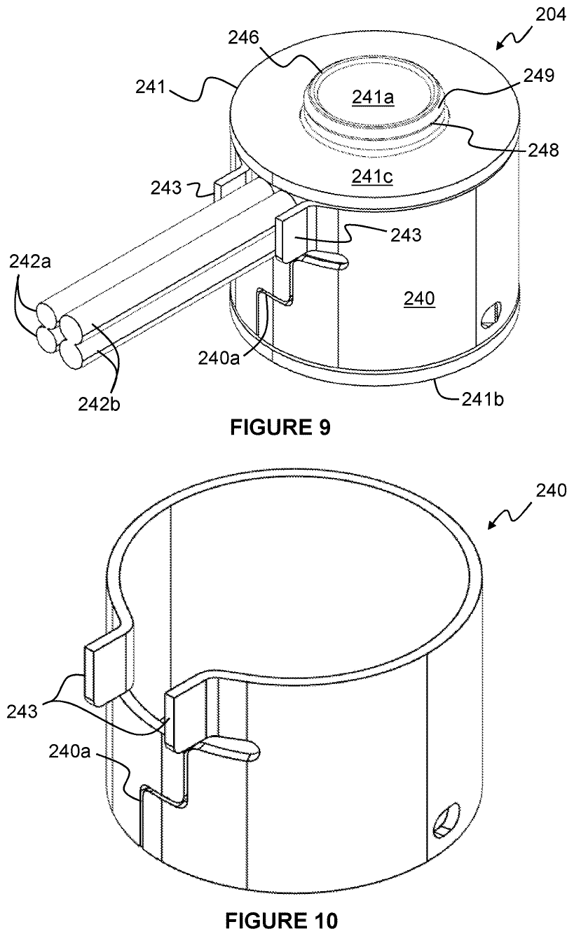

FIG. 9 is a perspective view of an alternative heater;

FIG. 10 is a perspective view of the protective sleeve of the heater of FIG. 9;

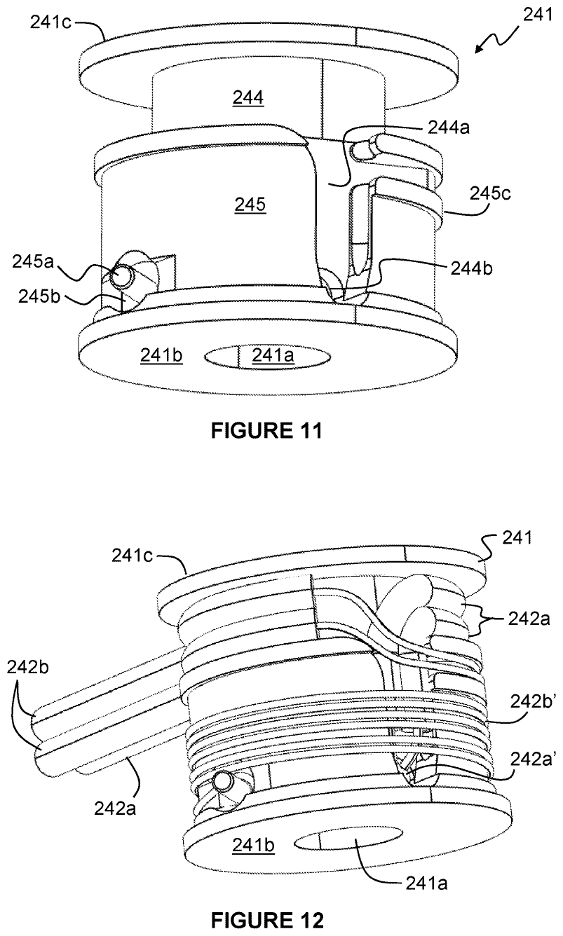

FIG. 11 is a perspective view of the mandrel of the heater of FIG. 9; and

FIG. 12 is a perspective view of the heater of FIG. 9 with the protective sleeve omitted.

Referring now to FIGS. 1 and 2, there is shown liquefier assembly 1 according to a first example, which includes a heat sink 2, a nozzle 3 releasably connected to the heat sink 2, a heater 4 biased against the nozzle 3 by a coil spring 5 and a fan assembly 6 mounted to the heat sink 2. The liquefier assembly 1 includes a connector 10 at a first end of the heat sink 2 for connection with a filament feed mechanism (not shown) of an additive manufacturing system (not shown), and is configured to facilitate replacement of the nozzle 3 in an unheated state. The connector 10 is in the form of a head 11 having a necked portion 12.

The heat sink 2 is shown more clearly in FIG. 3. The heat sink 2 includes a substantially cylindrical core 20 with a plurality of disc-shaped fins 21 projecting radially from the core 20 and a filament passageway 22 extending axially through the centre of the core 20 between its ends for receiving a filament from the filament feed mechanism (not shown). The passageway 22 includes an upstream portion 23 that is smooth, with a diameter that is slightly larger than the diameter of the filament (not shown) to be fed therethrough. The passageway 22 also includes a connection feature 24 extending along a downstream portion of the passageway 22. In this example, the connection feature 24 is in the form of internal threads.

The heat sink 2 also includes an engaging ring 25 surrounding the downstream end of the passageway 22 and projecting axially from the core 20. The engaging ring 25 has a tapered lead-in 26 and a lip 27 projecting radially outwardly from an intermediate portion thereof. The engaging ring describes a recess 28 surrounding the downstream end of the passageway 22. The skilled person will appreciate that, during assembly, the coil spring 5 is forced against the tapered lead-in 26 and over the lip 27, at which point the coil spring 5 snaps into place between the core 20 and the lip 27. This retains the coil spring 5 on the heat sink 2 at the downstream end of the passageway 22.

The nozzle 3 in this example, which is shown more clearly in FIG. 4, includes a connection sleeve 30, a nozzle tip 31, a liquefier tube 32 between the connection sleeve 30 and nozzle tip 31 and a tip cover 33 mounted over the nozzle tip 31. The connection sleeve 30 is formed of copper and includes an externally threaded tubular body 30a having a radial flange 30b at a downstream end. The liquefier tube 32 is formed of stainless steel, with a substantially constant diameter and thickness, and is received in an interference fit within the downstream end of the connection sleeve 30.

The nozzle tip 31, which is formed of brass in this example, includes a tubular body 34 at its upstream end and an enlarged head 35 at its downstream end. The tubular body 34 has a tapered external surface 34a. The enlarged head 35 includes a planar radial upper, heater-facing surface 35a, a frustoconical terminal end 36, which leads to an outlet 37 for molten material. The nozzle tip 31 includes a filament passageway 38 along its length that tapers within the frustoconical end 36 to the outlet 37, which has a diameter of approximately 0.40 mm in this example. However, several outlet sizes are envisaged without departing from the scope of the invention. The liquefier tube 32 is received within the upstream end of the filament passageway 38 in an interference fit.

The tip cover 33 in this example is substantially cylindrical with a first, open end 33a through which the head 35 of the nozzle tip 31 is inserted, and a flange 33b at the opposite end, against which the head 35 of the nozzle tip 31 abuts. The flange 33b describes an opening 33c through which the terminal end 36 projects. In this example, the tip cover 33 is formed of a silicone material and is retained on the head 35 of the nozzle by an interference fit. However, it is envisaged that the tip cover 33 may be formed of any suitable material, preferably but not necessarily an elastomeric material.

The tip cover 33 in this example serves several different purposes. Firstly, the tip cover 33 thermally insulates the head 35 of the nozzle tip 31, both to reduce heat loss in use and also to provide some protection against a user scalding herself when it is at an elevated temperature. Secondly, the tip cover 33 can inhibit the build-up of plastic on the nozzle tip 31, which might otherwise affect its operation. In fact, the tip cover 33 may be replaceable, for example if/when it becomes damaged and/or if plastic builds up on the tip cover 33 itself.

Another advantage of the tip cover 33 is that it may be colour coded to identify the type of nozzle 3 or nozzle tip 31 to which it is mounted. By way of example, the colour of the tip cover 33 may identify one or more characteristics of the nozzle 3 and/or nozzle tip 31, such as its wear resistance and/or thermal conductivity and/or its suitability for processing specific materials or class of materials. Other characteristics are also envisaged. This enables a user to identify, from their stock, the type of nozzle 3 easily and efficiently. In fact, the applicants have observed that identification markings on conventional nozzles can become worn or covered, in use, by material debris

Another advantageous, but optional feature of the tip cover 33 is that it may include one or more thermochromic pigments. The thermochromic pigment may be reversible, so that a user is able to determine quickly and easily whether the nozzle tip 31 and/or the head 35 is up to temperature and/or is too hot to touch. In some cases, the thermochromic pigment may be configured to change colour gradually, for example according to a predetermined scale. This could allowing a user to estimate the temperature of the nozzle tip 31 and/or the head 35.

In other examples, the thermochromic pigment may be irreversible. In such cases, the thermochromic pigment may be configured to indicate that the nozzle tip 31 and/or the head has been heated to a temperature above a predetermined threshold value. In some examples, part of the tip cover 33 may include a reversible thermochromic pigment, e.g. as described above, and another part of the tip cover 33 may include an irreversible thermochromic pigment, e.g. as described above.

The heater 4 in this example includes a cylindrical heater cover 40 that surrounds a heating sleeve 41. The heater cover 40 in this example is substantially cylindrical with a shallow internal lip 40a at each of its ends, which deforms as the heating sleeve 41 is inserted into the heater cover 40 and against which each end of the heating sleeve 41 abuts. In this example, the heater cover 40 is formed of a silicone material and is retained on the heating sleeve 41 by an interference fit. However, it is envisaged that the heater cover 40 may be formed of any suitable material, preferably but not necessarily an elastomeric material.

The heating sleeve 41 includes a tapered inner surface 41a, a planar radial lower, nozzle head-facing surface 41b and includes a heating coil (not shown) and temperature sensor (not shown) embedded within the sleeve 41. As illustrated more clearly in FIG. 5, the heater 4 also includes electrical wires 42 and a wire support 43 that extends radially from the sleeve 41 and supports the electrical wires 42 against unwanted movement. The wire support 43 includes a first, lower part 44 mounted to the side of the sleeve 41 by a pair of arms 44a and a second, upper part 45 mounted to the end of the sleeve 41 and secured to a projecting spigot 46 of the sleeve by a snap ring cover 45a. The first, lower part 44 and the second, upper part 45 of the wire support 43 include respective straight sections 44b, 45b, between which the electrical wires 42 are received, and wings 44c, 45c crimped around the electrical wires 42 to hold them in place.

The spigot 46 includes a stepped outer surface with a lip 47 projecting radially from the step, which retains the snap ring cover 45a in place, and a further lip 48 projecting radially adjacent the free end of the spigot 46. The spigot 46 also includes a tapered lead-in 49, which terminates at the lip 48. The skilled person will appreciate that, during assembly, the coil spring 5 is forced against the tapered lead-in 49 and over the lip 48, at which point the coil spring 5 snaps into place between the step and the lip 48. This retains the coil spring 5 on the heater 4 and thereby connects the heater 4 to the heat sink 2.

This connection between the heater 4 and heat sink 2, shown more clearly in FIG. 6, enables the heater 4 to move freely relative to the heat sink 2. More specifically, the nozzle 3 may be misaligned when inserted into the heating sleeve 41 of the heater 4, as illustrated in FIG. 6. As the connection sleeve 30 of the nozzle 3 is inserted into the downstream end of the passageway 22 of the heat sink 2, the nozzle 3 is then manipulated by the user into engagement and proper alignment with the heat sink 2 to enable the threads of the connection sleeve 30 to mesh with the threads of the connection feature 24 in the downstream portion of the passageway 22.

The skilled person will appreciate that the free movement of the heater 4 relative to the heat sink 2, by virtue of the coil spring 5, enables the nozzle 3 to be easily manipulated into engagement and proper alignment with the heat sink 2. This has been found to provide a better user experience, and also reduce the risk of cross-threading.

The nozzle 3 is then rotated to engage the threads of the connection sleeve 30 with those of the connection feature 24, which draws the nozzle tip 31 up toward and into the heating sleeve 41, until the tapered external surface 34a of the nozzle tip 31 engages the tapered inner surface 41a of the heating sleeve 41. This also brings the nozzle head-facing surface 41b of the heating sleeve 41 into engagement with the heater-facing surface 35a of the head 35 of the nozzle tip 31.

Further rotation of the nozzle 3 draws the nozzle tip 31 further toward the heat sink 2, which compresses the coil spring 5, until the radial flange 30b of the connection sleeve 30 is received within the recess 28 and abuts the outer surface of the core 20 surrounding the downstream end of the passageway 22 of the heat sink 2. At this point, the nozzle 3 is fully engaged with the heat sink 2 and the heater 4 is biased away from the heat sink 2 and toward the nozzle tip 31. As illustrated in FIG. 2, in this, fully engaged condition, the tip cover 33 is also urged into engagement with the heater cover 40, wherein the lowermost lip 40a of the heater cover 40 engages an upper, outer surface of the tip cover 33. This engagement between the tip cover 33 and the heater cover 40 inhibits ingress of molten plastic, thereby protecting the heating sleeve 41 and nozzle tip 31 from damage.

The spring bias imparted by the coil spring 5 also urges the tapered external surface 34a, inner surface 41a and planar radial surfaces 35a, 41b into biased thermal contact with one another. This is contrary to conventional arrangements, in which the nozzle tip is screwed directly into the heater, thereby relying on the preload caused by torqueing the nozzle tip within the heater for such thermal contact. The skilled person will appreciate that the process of screwing a nozzle directly into a heater requires the heater and nozzle tip to be at or near their operating temperature, in order to avoid unwanted loosening of the nozzle tip relative to the heater.

Thus, the arrangement of the invention enables the nozzle 3 to be mounted to the heat sink 2 in a cold condition. This has several advantages including, for example, lower health and safety risk and improved user experience. The skilled person will appreciate several other advantages associated with this arrangement. Indeed, the provision of the tip cover 33 further reduces the health and safety risk and improves user experience, particularly where the tip cover 33 incorporates a colour coding feature and/or the aforementioned thermochromic feature.

Turning now to FIGS. 7 and 8, there is shown a nozzle 103 according to another example, which is similar to the nozzle 3 described above, wherein like features are depicted with like references incremented by 100. The nozzle 103 in this example differs from the aforementioned nozzle 3 in that the outer surface 134a is cylindrical and not tapered, the tip cover 133 includes an internal lip 133d that engages a circumferential groove 135b in an outer surface of the head 135 of the nozzle tip 131 and the tubular body 130a, 130c of the connection sleeve 130 is un threaded.

In this example, the inner surface of the heating sleeve 41 is also cylindrical (not shown). As such, the bias of the spring 5 causes the heating sleeve 41 to slide along the outer surface 134a of the nozzle 103 until the planar radial surfaces 135a, 41b come into contact with one another. Thus, heat is transferred primarily through these surfaces 135a, 41b. However, the relative diameters of the cylindrical outer surface 134a and inner surface 41a are close, creating some thermal contact therebetween. The skilled person will appreciate that this arrangement is effective at providing sufficient heat to the nozzle tip 131 for its effective operation.

The internal lip 133d is triangular in cross-section, with a tapered upper surface facing the open end 133a of the tip cover 133 and a planar, radial lower surface on its opposite side. The circumferential groove 135b has a complementary shape, such that when the tip cover 133 is inserted onto the head 135 of the nozzle tip 131, the lip 133d of the tip cover 133 snaps into the circumferential groove 135b of the head 135, thereby to retain the tip cover 133 thereon.

Turning now to FIGS. 9 to 12, there is shown a heater 204 according to another example, which is similar to the heater 4 described above, wherein like features are depicted with like references incremented by 200. The heater 204 in this example differs from the previous heater 4 in its construction, but it is compatible with the other components of the liquefier assembly 1.

The heater 204 according to this example includes a protective sleeve 240 that surrounds a mandrel 241 and two pairs of electrical wires 242a, 242b. The protective sleeve 240 in this example, shown more clearly in FIG. 10, is substantially cylindrical, with a stepped split line 240a, a hole 240b through a lower portion and a pair of arms 243 bent outwardly along the split line 240a. A wire passage 243a is described between the arms 243. These arms 243 enable the protective sleeve 240 to be expanded, by forcing them apart using a tool (not shown), in order to fit the protective sleeve 240 over the mandrel 241. In this example, the protective sleeve 240 is formed of a stainless steel material, but it can be formed of any suitable material.

The mandrel 241, which is shown more clearly in FIG. 11, is formed of a copper alloy in this example, and includes a straight bore 241a, a planar radial lower, nozzle head-facing surface 241b and a spigot 246 projecting from a planar radial upper surface 241c. The straight bore 241a enables the heater 204 to be used with the nozzle 103 of FIGS. 7 and 8. The mandrel 241 also includes a circumferential cable groove 244 adjacent the upper surface 241c and a winding groove 245 between the circumferential cable groove 244 and the lower surface 241b. The winding groove 245 is shallower than the circumferential cable groove 244. An axial thermocouple groove 244a, which has a similar depth to the circumferential cable groove 244, extends from the circumferential cable groove 244 into the winding groove 245, and terminates at a thermocouple receptacle 244b that is deeper still. A winding pin 245a projects from the mandrel 241, within a recess 245b along a lower portion of the winding groove 245 and adjacent the lower surface 241b. A part-circumferential ridge 245c is also provided in an upper portion of the winding groove 245, on the opposite side of the axial thermocouple groove 244a, and describes a winding lead-in.

The spigot 246 includes a lip 248 projecting radially adjacent its free end, and a tapered lead-in 249, which terminates at the lip 248. The skilled person will appreciate that, during assembly, the coil spring 5 is forced against the tapered lead-in 249 and over the lip 248, at which point the coil spring 5 snaps into place between the step and the lip 248. This retains the coil spring 5 on the heater 204 and thereby connects the heater 204 to the heat sink 2.

As shown more clearly in FIG. 12, the first pair of electrical wires 242a is received within the circumferential cable groove 244, extend in a first direction around part of the mandrel 241 into the axial thermocouple groove 244a, and are electrically connected to a thermocouple 242a′ received within the thermocouple receptacle 244b. In this example, the second pair of electrical wires 242b are provided by a single wire with its sheath removed along an intermediate portion 242b′. The intermediate portion 242b′ is hooked onto the winding pin 245a and wrapped around the mandrel 241, within the winding groove 245, several times, and the sheathed portion if the electrical wire pair 242b lie within part of the circumferential cable groove 244, on the opposite side thereof to the first pair of electrical wires 242a. The exposed intermediate portion 242b′ of the second pair of electrical wires 242b is thus wrapped over the portion of the first pair of electrical wires 242a received within the axial thermocouple groove 244a, along the winding groove 245, and over the thermocouple 242a′ received within the thermocouple receptacle 244b.

As a result, the windings retain the first pair of electrical wires 242a within the axial thermocouple groove 244a and the thermocouple 242a′ within the thermocouple receptacle 244b. The thermocouple 242a′ is thereby embedded within the mandrel 241, and held therein by virtue of the windings of the second pair of electrical wires 242b retaining the first pair of electrical wires 242a within the axial thermocouple groove 244a. The windings of the second pair of electrical wires 242b also provide a heating coil surrounding the mandrel 241.

When the protective sleeve 240 is secured over the mandrel, the winding pin 245a projects into the hole 240b and the arms 243 are on either side of the electrical wires 242a, 242b, which extend through the wire passage 243a. The arms provide support to the electrical wires 242a, 242b and inhibit them from bending excessively, while the winding pin 245a provides a stop that engages the hole 240b to inhibit rotation of the protective sleeve 240 with respect to the mandrel 241. The skilled person will appreciate that this protects the windings from being overstressed and inhibits them from unwinding.

The heater 204 according to this example may, but need not, include a heater cover, which is not depicted in FIGS. 9 to 12. Its configuration would be similar to the heater cover 40 described above.

It will be appreciated by those skilled in the art that several variations to the aforementioned embodiments are envisaged without departing from the scope of the invention. For example, the assembly may include an interface material between the thermally contacting surfaces 34a, 134a, 41a and planar radial surfaces 35a, 135a, 41b. The interface material may comprise a graphene material. Additionally or alternatively, the thermally contacting surfaces 34a, 134a, 41a may be provided with a surface treatment or surface finish to improve their thermal conductivity. Cooperating features, such as ridges and grooves, may be incorporated within the thermally contacting surfaces 34a, 134a, 41a.

The nozzle 3, 103 need not include a tip cover 33, 133 and/or the heater 4 need not include a heater cover 40. The threaded connection between the nozzle 3, 103 and the heat sink 2 may be replaced with any other suitable connection, such as a bayonet, ball and detent, snap fit or any other suitable type of connection. Any of the aforementioned components may be formed of materials different to those described. The assembly may be provided in kit form. The kit may include a plurality of different nozzles 3, 103, for example each with different properties and/or having a tip cover 33, 133 with a different colour. The kit may include replaceable tip covers 33, 133.

It will also be appreciated by those skilled in the art that any number of combinations of the aforementioned features and/or those shown in the appended drawings provide clear advantages over the prior art and are therefore within the scope of the invention described herein.

1-35. (canceled)

36. A liquefier assembly for an additive manufacturing system, the assembly comprising:
a heat exchange body;
a heater connected to the heat exchange body by a resilient element; and
a nozzle releasably connected to the heat exchange body and having a nozzle tip at one end;
wherein the heater is between the nozzle tip and the heat exchange body when the nozzle is connected to the heat exchange body, and is biased away from the heat exchange body, toward the nozzle tip and into thermal contact with a surface of the nozzle.

37. The liquefier assembly of claim 36, wherein the resilient element comprises a resilient member with a first end connected to the heat exchange body and a second end connected to the heater such that the heater is able to move relative to the heat exchange body.

38. The liquefier assembly of claim 36, wherein the resilient element is tubular and its first end engagingly receives a projection of the heat exchange body and its second end engagingly receives a projection of the heater.

39. The liquefier assembly of claim 38, wherein the tubular resilient element comprises a coil spring.

40. The liquefier assembly of claim 36, wherein the nozzle comprises a connection feature for cooperating with a connection feature of the heat exchange body, a liquefier tube between the nozzle tip and the connection feature which spans a gap between the heater and the heat exchange body and the heater is biased into thermal contact with a surface of the nozzle tip.

41. The liquefier assembly of claim 36, wherein the thermally contacting surfaces of the heater and nozzle tip comprise one or more annular surfaces.

42. The liquefier assembly of claim 36, wherein the heat exchange body comprises a heat sink.

43. A nozzle for a liquefier assembly, the nozzle comprising:
a connection feature for cooperating with a connection feature of the heat exchange body;
a nozzle tip at one end, the nozzle tip having at least one annular surface for thermal engagement with the heater; and
a liquefier tube between the nozzle tip and the connection feature for spanning a gap between the heater and the heat exchange body;
wherein the outer profile of the nozzle is configured such that the heater is able to slide into abutting thermal contact with the annular surface of the nozzle tip.

44. The nozzle of claim 43, wherein the nozzle tip comprises a first material, the liquefier tube comprises a second material and the connection feature comprises a third material, the second material being less thermally conductive than the first material and/or the third material.

45. The nozzle of claim 43, wherein the nozzle comprises a first, connection sleeve part with the connection feature, a second, nozzle tip part and a third, liquefier tube part secured by an interference fit to the first and second parts.

46. The nozzle of claim 45, wherein the connection sleeve part comprises a stop between the connection feature and the nozzle tip for engaging the heat exchange body when the nozzle is engaged fully therewith.

47. The nozzle of claim 43 comprising a tip cover mounted over the nozzle tip for insulating the nozzle tip.

48. The nozzle of claim 47, wherein the tip cover has a lip that engages a shoulder of the nozzle tip to retain the tip cover thereon.

49. The nozzle of claim 47, wherein the tip cover comprises an indicator which identifies one or more characteristics of the nozzle tip to which it is mounted.

50. The nozzle of claim 47, wherein at least one of the tip cover and the nozzle tip comprises a thermochromic pigment.

51. The nozzle of claim 51, wherein the thermochromic pigment is reversible and configured to indicate the temperature of the nozzle tip.

52. The nozzle of claim 52, wherein the thermochromic pigment is configured to change colour gradually according to a predetermined scale for allowing a user to estimate the temperature of the nozzle tip.

53. The nozzle of claim 50, wherein the thermochromic pigment is irreversible and is configured to indicate that the nozzle tip has been heated to a temperature above a predetermined threshold value.

54. A heater for a liquefier assembly, the heater comprising a hole for slidingly receiving the nozzle of the liquefier assembly and a connector for connection with the resilient element of the liquefier assembly.

55. A heater according to claim 54, wherein the connector comprises an annular spigot surrounding the hole and having a lip projecting radially outwardly from the projection.
